(19) United States
(12) Patent Application Publication
(10) Pub. No.: US 2006/0201474 A1
(43) Pub. Date: Sep. 14, 2006

(54) Dual piston rotary engine

(76) Inventor: Michael Arseneau, Beauharnois (CA)

Correspondence Address: Hoffman, Wasson & Gitler, P.C., Suite 522, 2461 South Clark Street, Arlington, VA, 22202, US

(21) Appl. No.: 11/360,566

(22) Filed: Feb. 24, 2006

Related U.S. Application Data
(60) Provisional application No. 60/655,913, filed on Feb. 25, 2005.
(60) Provisional application No. 60/664,173, filed on Mar. 23, 2005.
(60) Provisional application No. 60/706,027, filed on Aug. 8, 2005.

(51) Int. Cl. F02B 53/00; F02B 57/08; F02B 75/26

(52) U.S. Cl. 123/241; 123/244; 123/44 E; 123/43 R

(57) ABSTRACT

A rotary engine includes a cylinder within a housing accommodating a pair of reciprocating pistons. A drive shaft extends from the cylinder to provide output power when rotated with the cylinder. A linkage attached to the top of each piston is connected to the driveshaft to translate the reciprocal motion of the piston to the rotational movement of the cylinder. An extension of the linkage fits within a cam surface in the end wall of the housing. The linkage can take one of several embodiments. The linkages have channels for distributing oil throughout the housing. Each piston face may have a central depression with a spiral channel leading from the edge of the piston to the depression.

This application claims benefit of provisional applications 60/655,913, filed Feb. 25, 2005; 60/664,173, filed Mar. 23, 2005 and 60/706,027, filed Aug. 8, 2005.

### BACKGROUND OF THE INVENTION

Two types of rotary engines include the Wenkel engine and the dual piston rotary engine. In a Wenkel engine, a triangular wedge within a cylinder forms three chambers for intake combustion and exhaust. Combustion of fuel causes the triangle wedge to rotate and a drive shaft extending from the triangular wedge provides power.

The second type of rotary engine includes a dual piston rotary engine including a housing and a single cylinder within the housing. A pair of pistons reciprocate within the cylinder. The reciprocated motion of the pistons translates to rotation of the cylinder by the sides of the piston pushing against the cylinder. The pistons have a bearing or other type of device engaging a cam surface about the interior of the housing allowing the pistons to have a four stroke movement with each revolution of the cylinder. A drive shaft extends from and is rotated by the cylinder. One such dual piston rotary engine is shown in GB 2020739.

There is a need in the art for a mechanism to efficiently translate the reciprocal motion of a piston to rotational movement of the cylinder.

It is an object of the invention to increase the efficiency of a dual piston rotary engine by transferring more power from the pistons to the cylinder.

It is another object of the invention to produce a dual piston rotary engine having smaller overall dimensions with a larger combustion chamber.

It is another object of the invention to provide a dual piston rotary engine that is easy and inexpensive to manufacture.

It is another object of the invention to provide a rotary engine having moving parts of a reduced weight to minimize centrifugal forces.

It is another object of the invention to provide a rotary engine having an efficient and reliable lubrication system.

These and other objects of the invention will be apparent to one of ordinary skill after reading the disclosure of the invention.

### SUMMARY OF THE INVENTION

A rotary engine includes a cylinder within a housing accommodating a pair of reciprocating pistons. A drive shaft extends from the cylinder to provide output power when rotated with the cylinder. A linkage attached to the top of each piston is connected to the driveshaft to translate the reciprocal motion of the piston to the rotational movement of the cylinder. An extension of the linkage fits within a cam surface in the end wall of the housing. The linkage can take one of several embodiments. The linkages have channels for distributing oil throughout the housing. Each piston face may have a central depression with a spiral channel leading from the edge of the piston to the depression.

### BRIEF DESCRIPTION OF THE DRAWINGS

FIG. 1 is a perspective view of the engine with portions cut away;

FIG. 2 is a cross-sectional view of the rotary engine at top dead center;

FIG. 3 is a cross-sectional view of the rotary engine at the bottom dead center;

FIG. 4 is a cross-sectional view of a second embodiment of the rotary engine at top dead center;

FIG. 5 is a cross-sectional view of a second embodiment of the engine at bottom dead center;

FIG. 6 is a cross-sectional view of a rotary engine having a square cam at top dead center;

FIG. 7 is a cross-sectional view of a rotary engine having a square cam at bottom dead center;

FIG. 8 is a side cross-sectional view of the cylinder having intake and exhaust ports at opposite ends of the combustion chamber;

FIG. 9 is a view along line C-C of FIG. 8;

FIG. 10 is a view along line A-A of FIG. 8;

FIG. 11 is a view along line D-D of FIG. 8;

FIG. 12 is a view along line B-B of FIG. 8;

FIG. 13 is a top view of the piston face;

FIG. 14 is a cross-sectional view of a first embodiment at bottom dead center;

FIG. 15 is a cross-sectional view of a first embodiment at top dead center;

FIG. 16 is a view along line B-B of FIG. 15;

FIG. 17 is a side view of the first embodiment at top dead center;

FIG. 18 is a side view of the cylinder;

FIG. 19 is a cross section view along line 6-6 of FIG. 18;

FIG. 20 is a side view of the engine having an oil bearing at bottom dead center;

FIG. 21 is a view along line A-A of FIG. 20;

FIG. 22 is a view along line C-C of FIG. 21;

FIG. 23 is a cross-sectional view of a second embodiment at bottom dead center;

FIG. 24 is a cross-sectional view of a third embodiment at bottom dead center;

FIG. 25 is a view along line A-A of FIG. 24;

FIG. 26 is a view along line B-B of FIG. 24;

FIG. 27 is a cross-sectional view of the fourth embodiment at bottom dead center;

FIG. 28 is a cross-sectional view of the two stroke version of the engine at top dead center;

FIG. 29 is a cross-sectional view of the two stroke engine at bottom dead center;

FIG. 30 is a view along line A-A of FIG. 29;

FIG. 31 is a view along line B-B of FIG. 29;

FIG. 32 is a cross-sectional view through the cylinder of the two stroke engine;

FIG. 33 is a cross-sectional view of a rotating cam and stationary cylinder version of the engine at top dead center;

FIG. 34 is a cross-sectional view of an alternative embodiment of the invention at top dead center;

FIG. 35 is a cross-sectional view of the engine of FIG. 41 at top dead center;

FIG. 36 is a detailed view of the subject matter within the circle of FIG. 35;

FIG. 37 is a view along line A-A of FIG. 36;

FIG. 38 is a cross-sectional view of the cylinder of the engine showing the oil flow path;

FIG. 39 is a cross-sectional view of the dual piston rotary engine;

FIG. 40 is a detailed view of the cam follower and oil distribution of the engine;

FIG. 41 is an alternative embodiment of the oil distribution to the cam follower;

FIGS. 42a-c are views of a cam follower having oil rings;

FIGS. 43a-d are cross-sectional views of alternative cam followers;

FIG. 44 depicts end views of the intake and exhaust valves;

FIGS. 45a-c are side and end views of the linkage;

FIG. 46 shows the oil distribution baffles of the engine;

FIG. 47 shows the engine equipped with a pressurized oil reservoir; and

FIGS. 48a-c are end and side views of the cylinder.

### DETAILED DESCRIPTION OF THE INVENTION

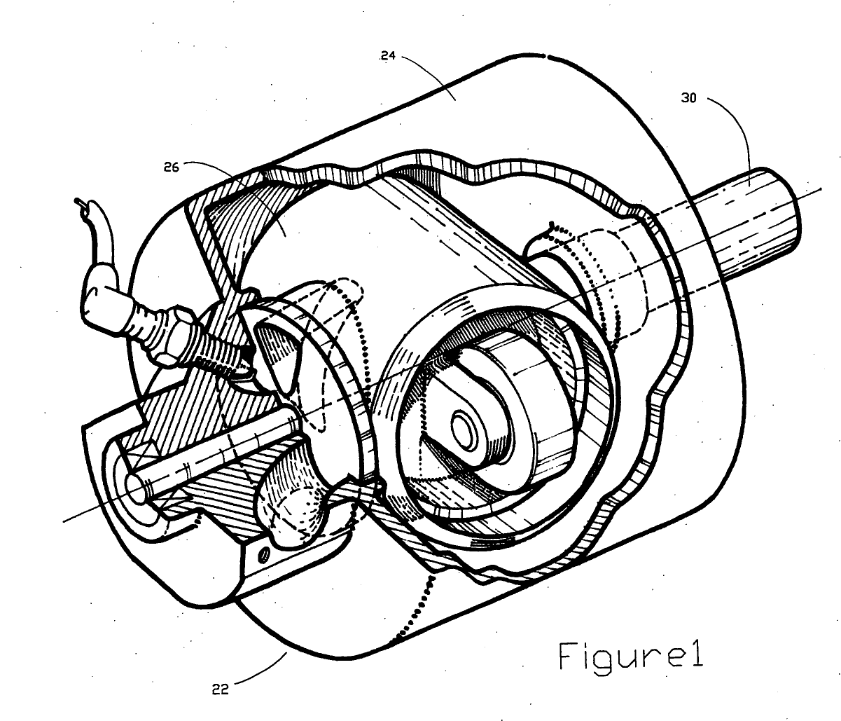

The dual piston rotary engine 10 is seen in FIG. 1 with part of the housing 20 removed to see details of the interior. The housing has ends wall 22, 24. Within the housing is cylinder 26, otherwise referred to an a rotor. A drive shaft 30 attached to the cylinder extends from the housing 20. Reciprocal motion of the pistons is translated into rotation of the drive shaft 30.

FIG. 2 is a cross sectional view of the rotary engine 10. Within the casing is cylinder 26 and pistons 51,53. Extending from the pistons are yokes 86 and 88. As can be seen in this view, the yokes are offset from the center with yoke 88 slightly above centerline 80 and yoke 86 slightly below centerline 80. For low speed engines that generate low centrifugal forces, a cam follower 32, 34, such as bearings, is attached to the yokes. FIG. 1 depicts top dead center with combustion chamber 52 at its smallest volume.

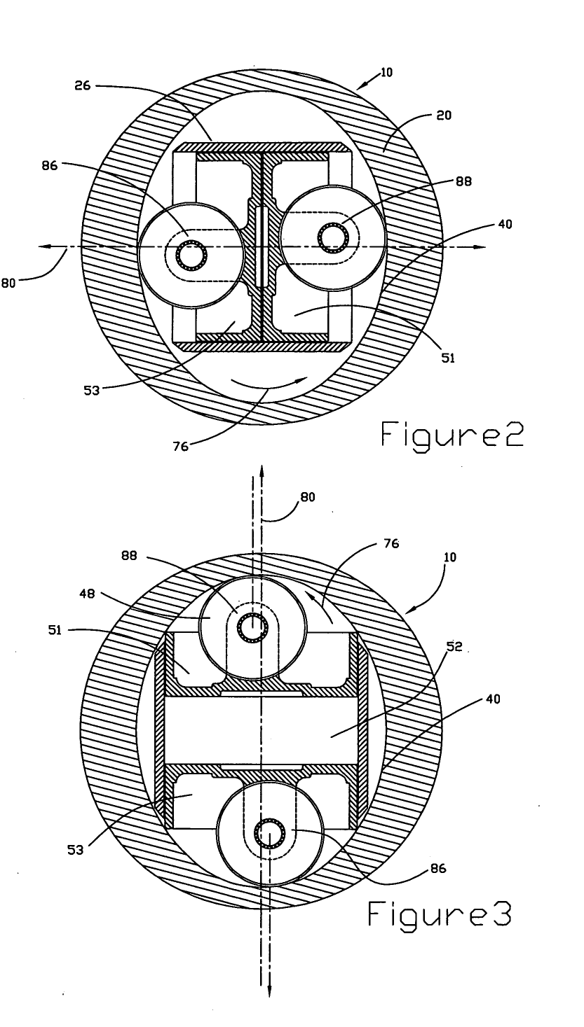

FIG. 3 shows the cylinder 26 displaced 90° to bottom dead center with the combustion chamber 52 at its largest volume. Yoke 86 is now to the right of centerline 80 and yoke 88 is to the left of the centerline 80. The off-center arrangement of the yoke allows more of the outward motion of the pistons 51,53 to be translated into rotational movement.

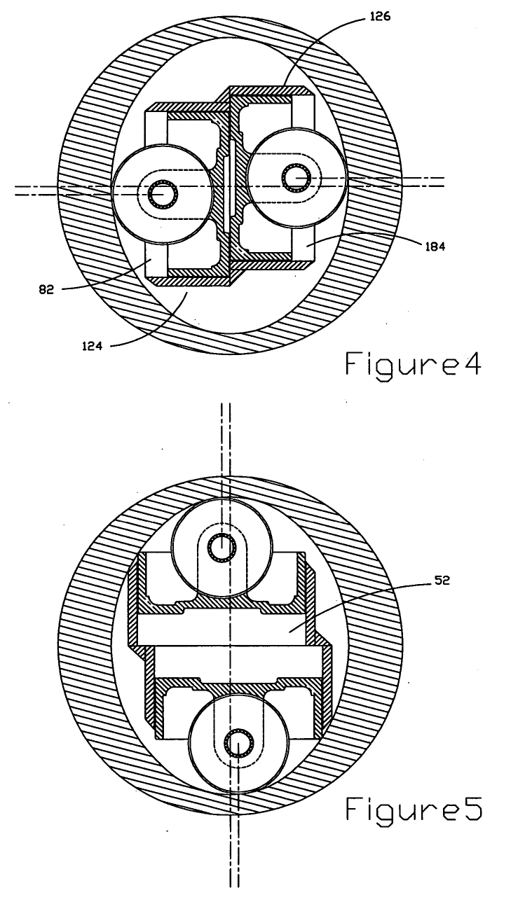

FIG. 4 shows a second embodiment of the rotary engine at top dead center. In this embodiment, the cam followers are again displaced from the centerline 180. However, the displacement is caused by the cylinder 26′ having two offset halves 124, 126. The displacement of the cylinder sidewall halves relative to one another results in the offset yokes of the pistons. FIG. 4 shows top dead center with the combustion chamber at its smallest volume whereas FIG. 5 shows the cylinder displaced 90° in the direction of rotation at bottom dead center and the combustion chamber at its largest volume.

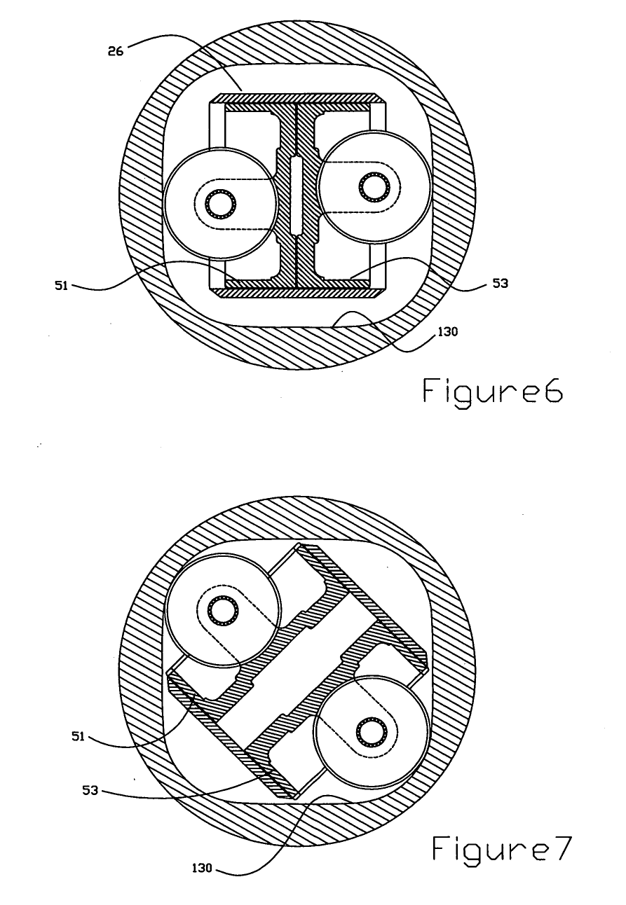

FIG. 6 shows an embodiment having the casing with a square cam 400 with the pistons at top dead center. FIG. 7 shows the cylinder displaced 45° so as to have the pistons at bottom dead center. In this embodiment, as in the first embodiment, the yokes of the piston are offset from center.

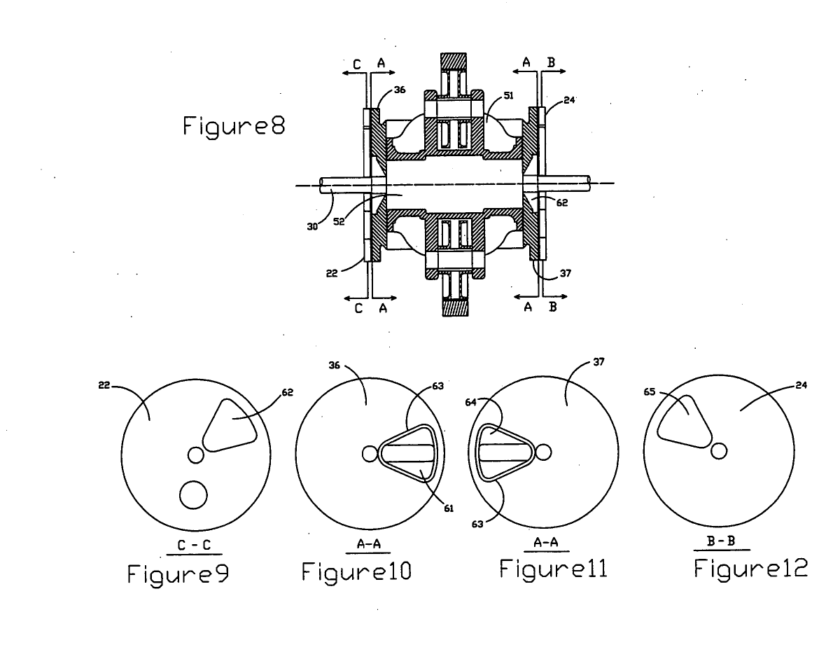

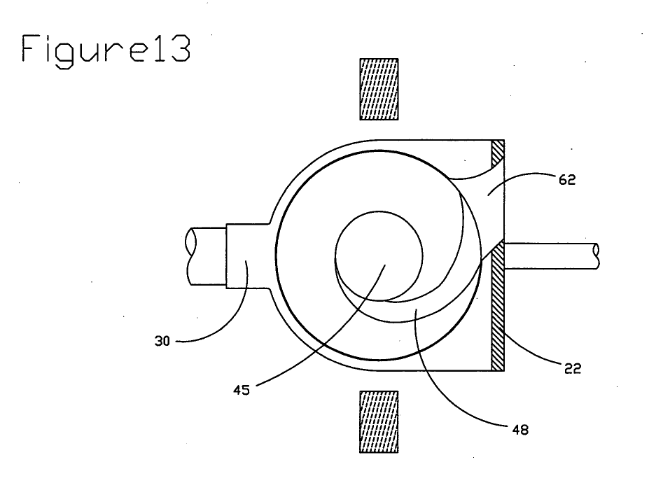

FIG. 8 shows a side cross-sectional view of a cylinder and pistons having intake and exhaust ports at opposite ends of the cylinder. At the left end is housing sidewall 22 having exhaust port 62 and ignition port 66. Next to the sidewall is disk 36 forming part of the cylinder and having port 61 provided with seal 63 about the triangular, outward end. The port transitions from a triangular port to a rectangular port as it proceeds from the outer to inner surface, with the rectangular port in communication with the combustion chamber 52. At the other end of the cylinder is disk 37 having port 64 also provided with a seal 63. The seal insures a proper communication with the intake port 65 on housing sidewall 24. FIGS. 9, 10, 11 and 12 show the views of each disk as indicated in the drawings.

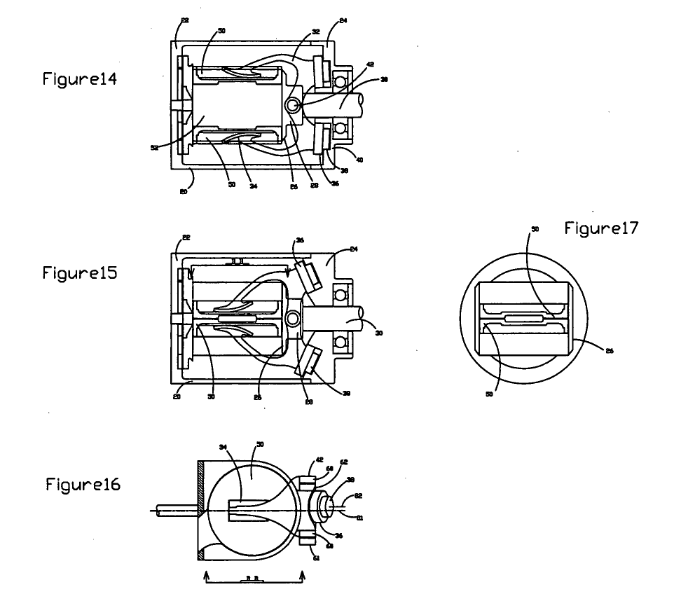

FIG. 13 is a view showing the top surface of the piston 52 having the central depression 45. The surface of the piston is provided with a spiral channel 48 extending from the intake port 62 towards the central depression to improve the fuel flow within the combustion chamber.

FIG. 14 shows housing 20 having a first end wall 22 and a second end wall 24. Within the housing is cylinder 26 having a hub 28 and drive shaft 30 extending therefrom. A pair of pistons 50 are retained within the cylinder 26 and form combustion chamber 52 therebetween. In this embodiment, the linkage is a rocker arm 32 having one end terminating in a sled 34 which contacts the top of the piston. The sled is slightly arcuate in order to contact the top of the piston through the varying angle between the rocker arm and piston, as will be explained later. The second end of the rocker arm is attached to the hub 28 to form a pivot 42.

A cam 40 is formed in the second end wall 24. An extension of the rocker arm 32 has a first bearing 36 and second bearing 38 fitting within the cam 40. The upward stroke of the piston causes upward motion of the sled and counterclockwise rotation of the rocker arm 32 about the pivot 42. This counterclockwise rotation about the pivot causes the first bearing to press against the inner surface of the cam 40. Similarly, downward motion of the piston causes clockwise rotation of the rocker arm about the pivot 42 and the second bearing presses against the outer surface of the cam. The first bearing is larger and engages the inner surface of the cam and the second bearing is smaller and engages the outer surface of the cam. The bearings may be the same size or the second bearing may be larger than the first without affecting the function of the bearings.

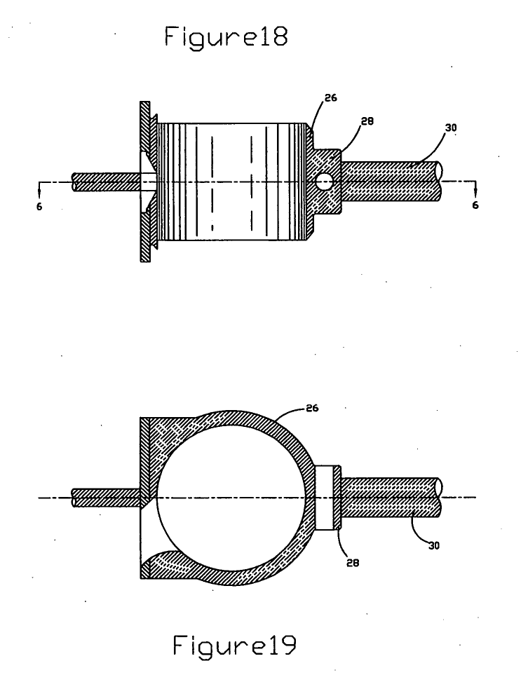

FIG. 15 shows the engine at top dead center, with the combustion chamber at its minimum volume. The bearings are now further from the centerline of the housing. Also, the bearings move inwardly, along the cam surface, towards the cylinder 26. As the linkage has a fixed length, the upward and inward movement of the bearings ensure that the sled stays in contact with the piston as the bearings moves about the cam 40 and forms varying angles between the rocker arm and piston.

FIG. 16 shows the rocker arm 32 and piston 50 with the sled 34 as it contacts the piston 50. In this view, the top edge of the rocker arm extends to the outer knuckle 60 with the lower edge of the rocker arm extending to the inner knuckle 60′. The other pair of knuckles 62, 62′ seen in the figure are part of the rocker arm contacting the other piston. In this way, the two rocker arms are identical and can be used with either piston. The weight about a horizontal line extending through the center of the pivot 42 is balanced by having the weight of the two rocker arms balanced. Also, the weight about a vertical line through the center of pivot 42 is balanced by forming each rocker arm with equal weight on both sides of the vertical line.

The centerline of the piston and rocker arm 81 are seen in the drawing. Also seen is the center line 82 of the bearings being offset from and in front of the centerline 81 in the direction of rotation. This places the bearings 36,38 advanced in the cam to translate more of the reciprocal motion of the pistons to rotational motion of the cylinder.

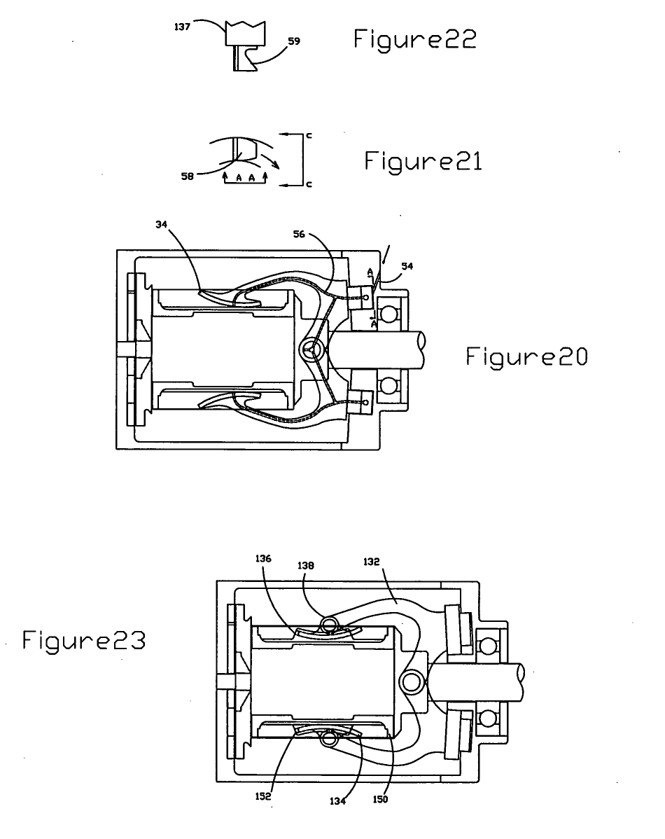

FIG. 17 shows an end view of the two pistons at top dead center. In this view, it can be seen that the height of the pistons is minimal as the sides of the pistons are not relied upon for pressing against the cylinder 26 in order to cause rotational motion.

FIG. 18 is a side view of the cylinder 26 having the hub 26 for attachment of the rocker arms and drive shaft 30 rotated with the cylinder. FIG. 19 is a cross sectional view along the center line of the cylinder. Seen in this view is the aperture through the hub 28 for holding the pivot 42.

FIG. 20 is the same as FIG. 14\but show a engine having an oil bearing 137 in place of a first and second bearing. FIG. 20 shows oil port 54 with oil channel 56 extending through the rocker arm and having an exit at the end of the sled. Although only one oil port is shown, it is understood that any number of oil ports may be used to insure adequate lubrication.

FIG. 21 shows the end view of the bearing within the cam having the tapered terminal edge 58. FIG. 22 shows the top view of the bearing with a scoop-like projection 59 forming the leading edge 59 and leading to the oil channel 56. The cylinder rotates and the centrifugal forces force oil from the sled 34 away from the combustion chamber, helping to prevent oil from being burned within the combustion chamber.

FIG. 23 shows the second embodiment of the invention having an alternative linkage. Only the differences between the second embodiment and first embodiment will be discussed as the common elements have been fully described earlier. In this embodiment, sled 134 fits within a groove 152 formed on piston 150. The sled slides within the groove and is retained thereby by the mating configurations of the sled and groove. One such example is a T-shaped groove allowing the sled 134 to slide within the groove and still have an upward projection 136. The projection 136 from the sled is pivotally connected to the rocker arm 132 at pivot 138.

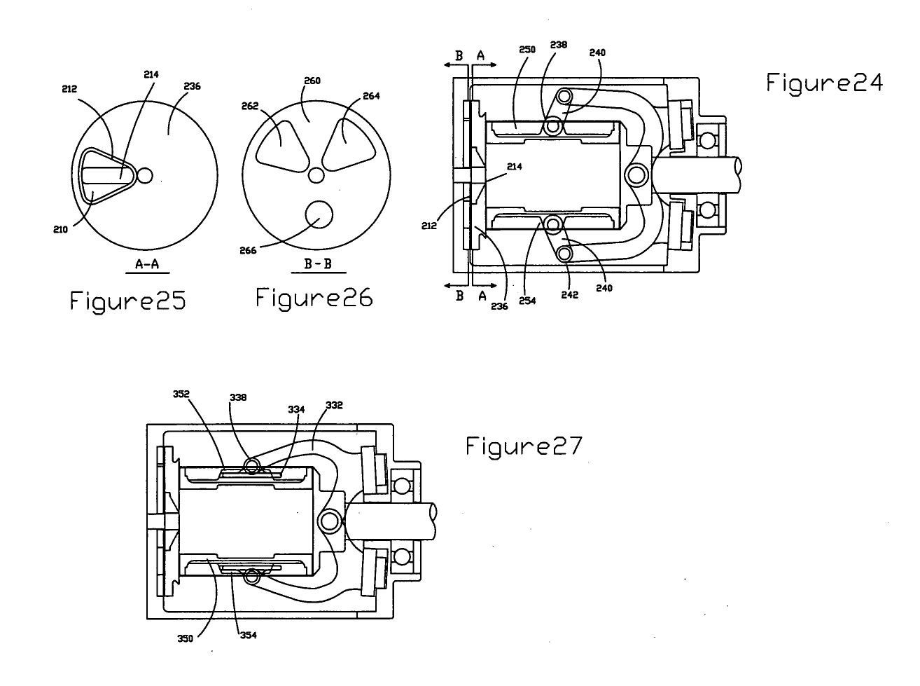

FIG. 24 shows the third embodiment of the rotary engine having a piston 250 with a projection 254. A link 240 is pivotally connected to the projection 254 at pivot 238. The second end of the link 240 pivotally connects to the rocker arm 232 at pivot 242.

FIG. 25 shows the sidewall 236 of the cylinder having an intake port 210. The sidewall transitions from the curved wall of the cylinder to a flat circular disk. The left side of the end wall is disk-shaped and the right side is curved to form the sidewall of the cylinder. The intake port transitions from a wedge shape 212 to a rectangular shape 214 at the combustion chamber. Forming part of the cylinder sidewall, the intake port 210 rotates with the cylinder. A second disk 260, seen in FIG. 26, has corresponding an intake port 262 and exhaust port 264 as well as a port 266 for accommodating a spark plug if combustion needs an igniter. Such a spark plug is not necessary for a diesel version of the rotary engine.

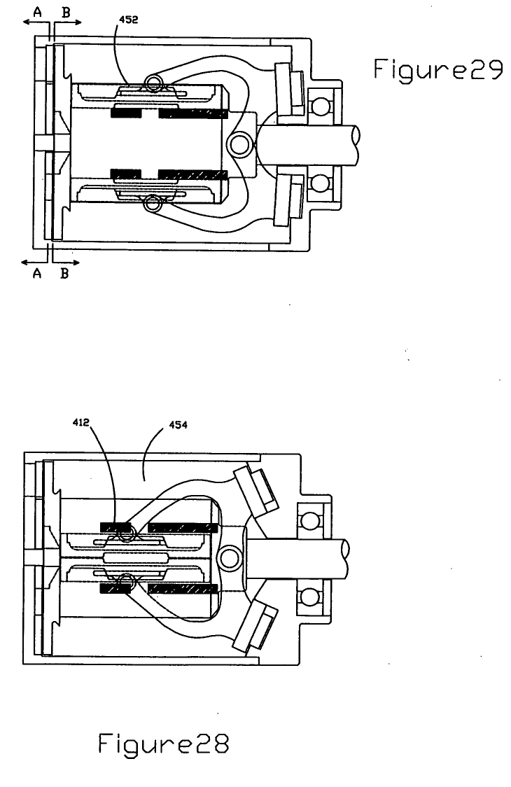

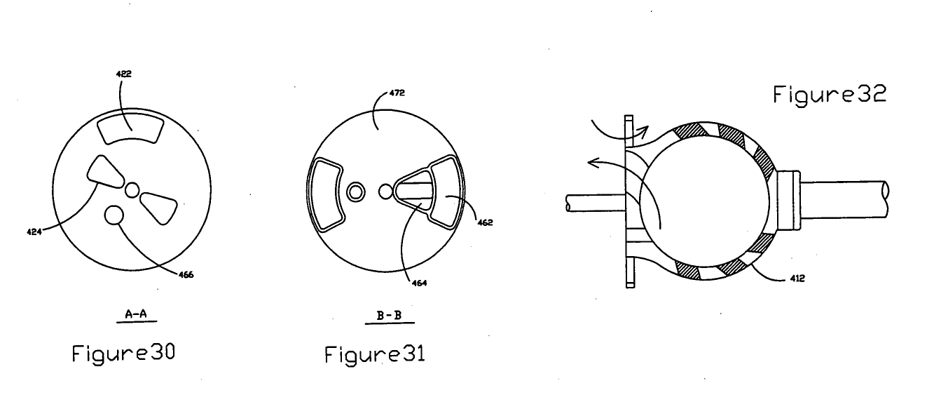

FIG. 27 shows the fourth embodiment of a rotary engine with a piston 350 having a projection 354. The linkage is a rocker arm 332 having a pivot connection 338 a sled 334 sliding with in a groove 352.

FIG. 28 shows a two stroke version of the engine with the pistons at top dead center. The combustion chamber 452 is formed between the pistons and the remaining volume within the casing of the engine is the crankcase 454. Formed within the cylinder are intake ports 412. As can be seen in FIG. 28, with the pistons at top dead center, the ports 412 do not communicate with the combustion chamber 452. Likewise, FIG. 29, showing the pistons at bottom dead center, reveals that the intake ports 412 now communicate with the combustion chamber 452 allowing fuel from the crank case 454 to enter into the combustion chamber, as will be described later.

FIG. 30 shows the left side of the housing 20 with a single intake port 422 and exhaust ports 424. Also shown is a third port 466 for receiving a spark plug.

FIG. 31 shows the disk 472 forming the left side of the cylinder with two intake ports 462 and an exhaust port 464 tapering from a wedge shape to a rectangular shape leading to the combustion chamber. In a two stroke engine, there are two combustion cycles with one complete revolution of the cylinder. Therefore, there are two intakes with each revolution. It is possible that the left side of the casing has two intake ports and the disk 472 has one intake port. It is only necessary that with each half revolution of the cylinder, intake ports on the left side of the housing and the disk 472 become aligned. It is not critical which has a single intake port and which has two intake ports, as any combination will allow the alignment of the intake ports every half revolution.

FIG. 32 shows the flow of combustion and exhaust gases through the ports. As can be seen, the arrow shows exhaust leaving the combustion chamber through the exhaust port and intake gases extending into the crank shaft, outside of the cylinder. The intake gases then enter into the combustion chambers through the intake ports 412.

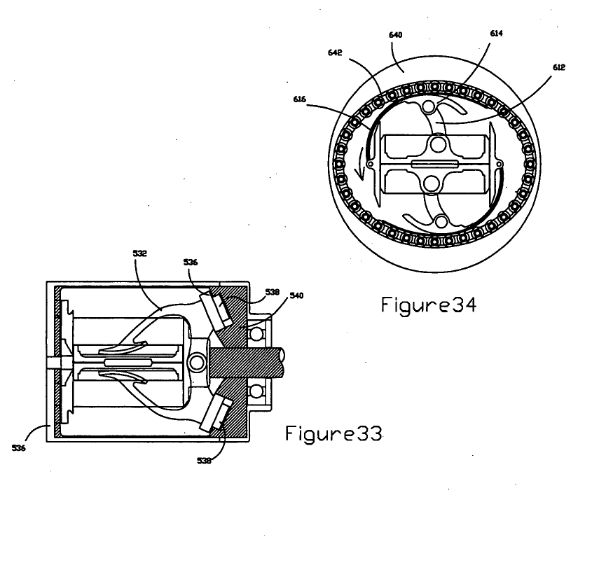

FIG. 33 shows an alternative embodiment of the engine with a casing with a cam 540 rotatable therein. The cam is connected to the left disk 537 having intake and exhaust ports, similar to FIG. 25, but in this instance, the disk 537 rotates with the cam 540 as they are connected by sidewall 531. The cylinder 526 and rocker arms 532 do not rotate and reciprocating motion of the piston, causes pivoting motions of the rocker arms, in turn causing the bearings 536,538 to rotate the cam 540. The left side of the cylinder is formed by a disk 560, similar to that shown in FIG. 26. However, with the cylinder being stationary, the disk also remains stationary, but the disk 536 rotates allowing the intake and exhaust ports formed within the two disks to come into registry to allow exhaust and intake.

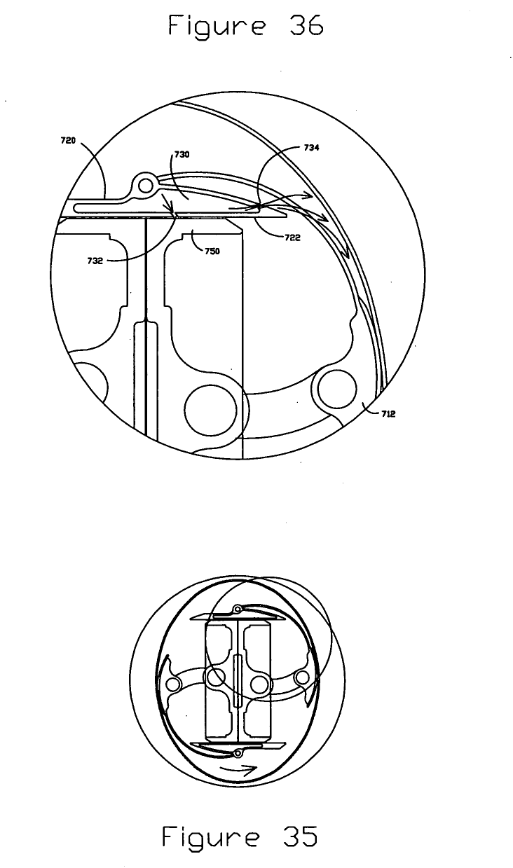

FIG. 34 shows an embodiment of the invention having cylinder and pistons with a linkage 612 pivotally connected to the top of the piston and pivotally connected to a sled 614. An elliptical cam 640 within the casing is lined with bearings 620. A blade 616 extends from the end of the sled 614 and connects to the side of the cylinder. Reciprocal motion of the pistons causes the sled 614 to move along the bearings of the cam and cause rotation of the cylinder. In the manner already described, the rotation of the cylinder causes rotation of a drive shaft.

FIG. 35 is similar to FIG. 34, but the cam has no bearings. The sled 712 slides along the cam 740, which is lubricated with an oil distribution system to be described later.

FIG. 36 shows a detailed view within the circle of FIG. 35. The arrows indicate the flow of oil from a passage within the cylinder 720. A first port 732 extends oil through the cylinder inner wall 722 to provide lubrication between the piston 750 and cylinder 720. Further oil, under centrifugal forces, exits from port 734 in the top of the cylinder and deposits lubrication in front of the sled 712.

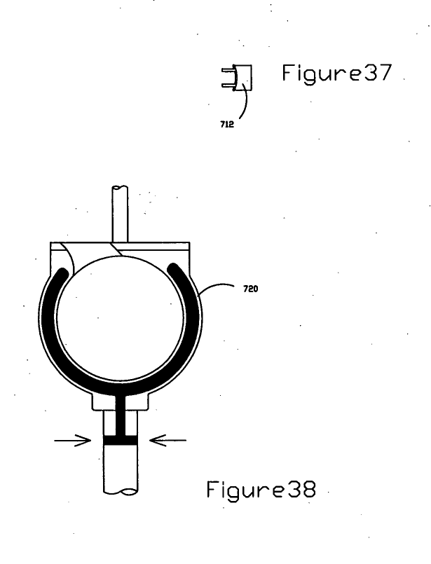

FIG. 37 is a view along line A-A and shows the cross sectional of the sled 712.

FIG. 38 shows the oil path as it extends through the passage in the cylinder. Centrifugal forces distribute the oil through the cylinder. Also, oil extending through the inner wall 722 of the cylinder between the cylinder and piston 750 is driven away from the combustion chamber by centrifugal forces.

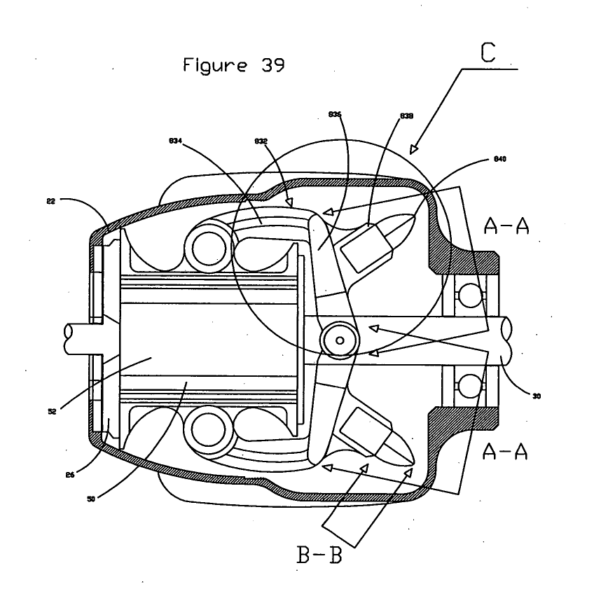

As can be seen in FIG. 39, the cylinder 26 has a varying height, with the front end having a greater height than the rear end. The lower rear end provides greater clearance for the linkage 832 and the greater height of the cylinder front end allows for more stability of the reciprocating pistons. The side wall of the pistons 50 accordingly have a varying height with the piston wall being greater where it contacts the higher cylinder wall. The extent of contact between the piston sidewall and the interior of a cylinder leads to greater stability during reciprocating motion of the piston within the cylinder.

The linkage 832 connects the piston to the drive shaft 30 and is responsible for translating the reciprocal motion of the piston into rotational motion of the drive shaft. The linkage 832 has two sections, a connecting rod 834 and an arm 836. The connecting rod and arm are rigidly connected and may be formed as one piece out of any suitable material, such as steel or the connecting rod 834 may be made out of steel with the arm 836 made out of a lightweight strong material, such as aluminum. The details regarding the linkage 832 will be described later. Seen in this view, however, is the connecting rod pivotally connected to the top of the piston 50 and bottom of the arm 836 pivotally connected to a hub 828. The hub is freely movable along the axial length of the drive shaft 30 but is connected, such as by key or spline, so that rotational motion of the hub relative to the drive shaft 30 is not possible. In this way, the rotational motion of the linkage 832 is translated through the hub, to drive shaft 30.

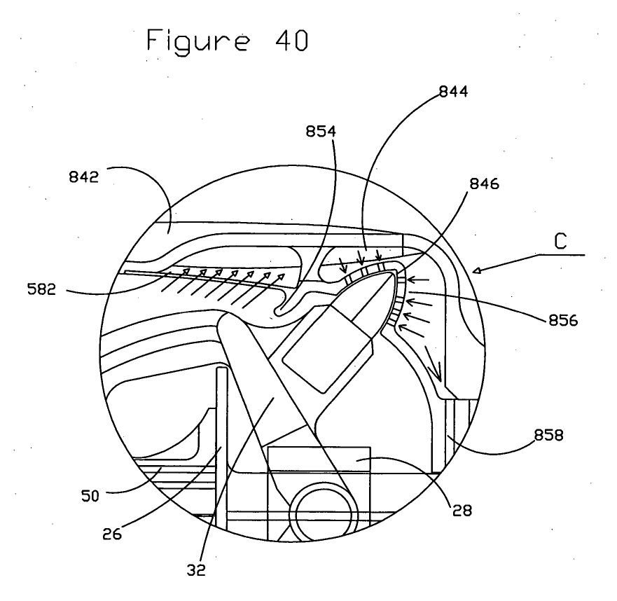

FIG. 40 is a detailed view of the oil distribution system and the cam follower. An extension 838 holds cam follower 840 which travels within cam 846. The cam follows the correct angular and elevation for the angle of the linkage 832 as it oscillates through the reciprocating motion of the piston 50. Also seen in this view is the oil jacket 852 showing the direction of oil flow from the internal cavity of the housing into the oil jacket. The oil is driven by centrifugal force, to be explained later. To assist the oil travel from the cavity into the oil jacket, an oil scoop 854 is formed inwardly of the cam 846. Continuing introduction of oil into the oil jacket forces oil through the jacket and into oil channels 856 in the cam 846 to provide lubrication between the cam and cam follower 840. Remaining oil travels downward into oil channel 858, eventually through the drive shaft 30 as will be more clearly depicted later. Also seen in FIG. 40 is exterior fin 42 and interior fin 844 within the oil jacket 852. These fins assist in the cooling of the engine by providing increased surface area over which heat transfer occurs. A water jacket may be formed about the housing if additional cooling is needed.

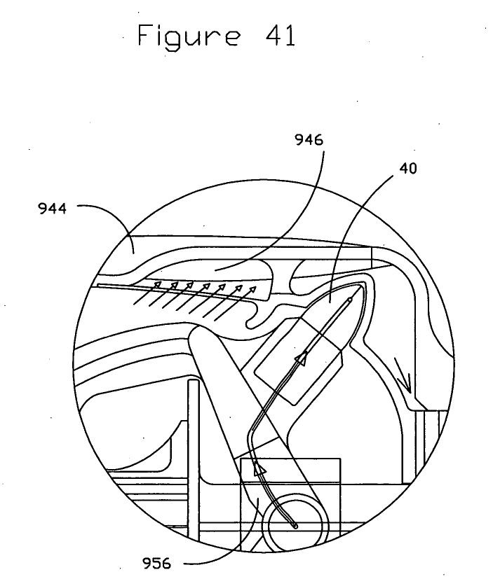

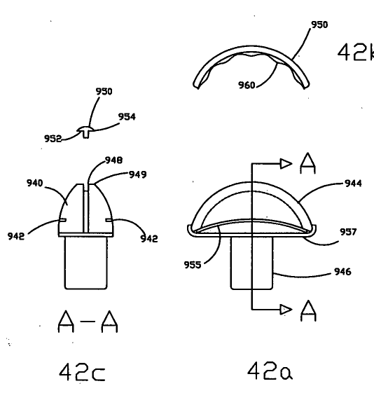

FIG. 41 shows a second embodiment of the oil distribution system. In this instance, the oil channels 856 are replaced with an oil channel 956 extending upward through the linkage 832. The oil channel 956 extends from the oil channel formed in the drive shaft 30.

FIG. 42a shows a side view of the cam follower having a top rounded section 944 and a lower stem section 946. A lateral ring 955 extends outwardly from each side of the rounded section 944. A retainer 957 extends along the bottom of the rounded section 944 and retains the lateral rings 955 and center ring within their respective grooves. A center ring 950 extends along the top of the rounded section 944. FIG. 42(b) depicts a spring 960 extending along the bottom edge of the center ring, as will be described later.

The cross-sectional view along line A-A is also seen in FIG. 42(c). In this view, the lateral rings are not shown but the grooves 942 in the side of the rounded section are clearly seen. Similar to the center ring, a spring urges each lateral ring outwardly, into contact with the cam. The center groove 948 is also seen as it extends along the middle of the rounded section 944. The center ring 950 has a top curved surface 954 and flat bottom surface 952. In use, the center ring fits within the center groove 948. The flat surface 952 has the same dimensions as the top surface 949 of the rounded section 944. In so doing, the center ring completes the curved profile of the top rounded section 944.

As mentioned previously, spring elements urge the lateral rings and center rings outwardly into contact with the cam. As seen in FIG. 41, one side or the other of the cam follower presses against the cam during movement of the cam follower around the cam. The rings establish an oil film between the center ring and lateral ring, ensuring that whichever surface of the cam follower being pressed against the cam has sufficient lubrication trapped between that side lateral ring and the center ring.

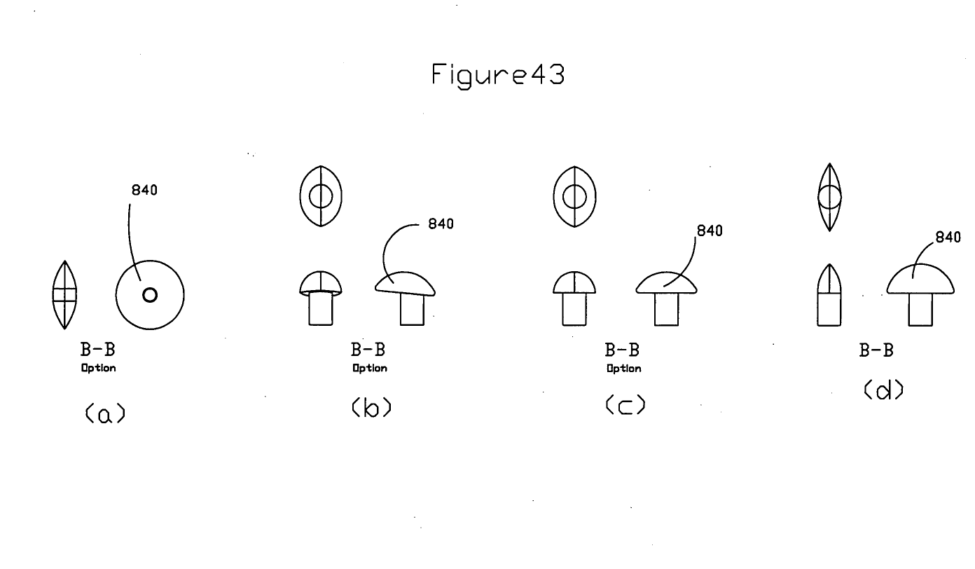

FIGS. 43a-d shows alternative shapes for the cam follower 840″, 840″′ and 840″″. FIG. 43(d) depicts the cam follower 840 of FIG. 40. Each of the cam followers has a top rounded surface. The cam follower acts in the manner of a ski as it travels through the cam on the lubrication.

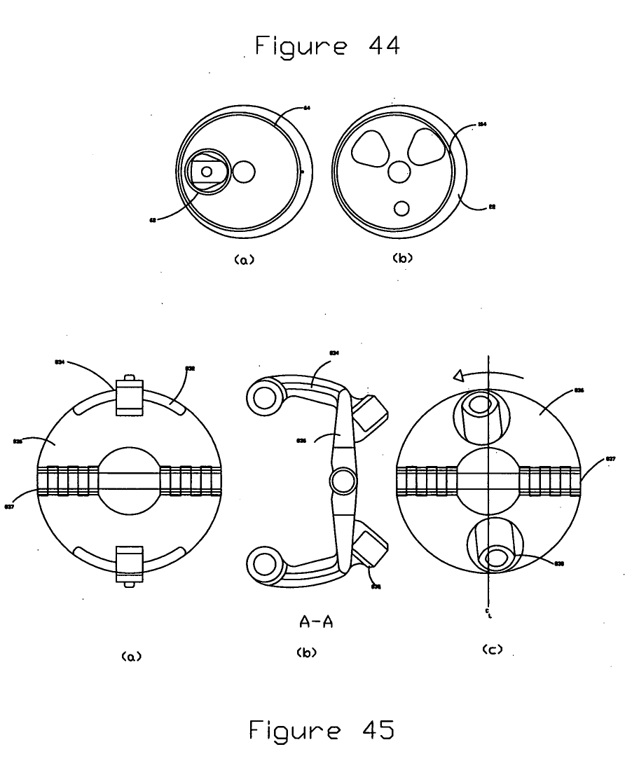

FIG. 44 shows the two components forming the intake/out-take valve system of the invention. FIG. 9a shows the disk forming the front end of the cylinder which, obviously, rotates with the cylinder. During its rotation, it comes into registry with the intake and exhaust apertures of the housing end wall 22. The first seal 62 is formed about the valve opening. When the valve opening is in registry with the intake and exhaust apertures formed in the housing end wall, the seal 62 prevents exhaust or fuel from escaping. However, it is often the case that the valve opening is not in complete registry with the intake and exhaust allowing a pathway for exhaust end fuel into the space between the housing end wall and cylinder. Left unchecked, these components will easily and quickly contaminate the oil within the engine and lead to great problems. For that reason, a second seal 64 is formed in the cylinder sidewall or a seal 164 is formed in the housing end wall. As can be seen, the seal 64 is eccentric to the cylinder front end wall. It is large enough so as to always surround the intake and exhaust ports in the housing end wall throughout rotation but, by being eccentric, won't contact the same portion of the housing end wall during rotation. If the seal is formed in the housing end wall, as seal 164 seen in the figure, the same effect is had as the seal 164 is eccentric yet surrounds the intake and exhaust ports and, during rotation of the cylinder, does not wear in the same place on the cylinder front end wall.

FIGS. 45a-c shows the front end, side and back end views of the linkage 832. In FIG. 45a, the front end view shows the connecting rod 834 extending from the top edge of the arm 836. Arm 836 is formed as a semicircle and is hingedly connected to the other semicircular arm 836. The hinge pin is rigidly connected to the hub, not shown, so that rotational movement of the arm 836 is translated to the hub. The side view of the linkage is seen in FIG. 45b. The back end view is shown in FIG. 45c. The interesting feature clearly seen in FIG. 45c is the offset of the cam extensions 838 from the center line perpendicular to the hinge line of the two arms 836. The offset of the cam extension results in advanced timing of the combustion relative to the piston stroke.

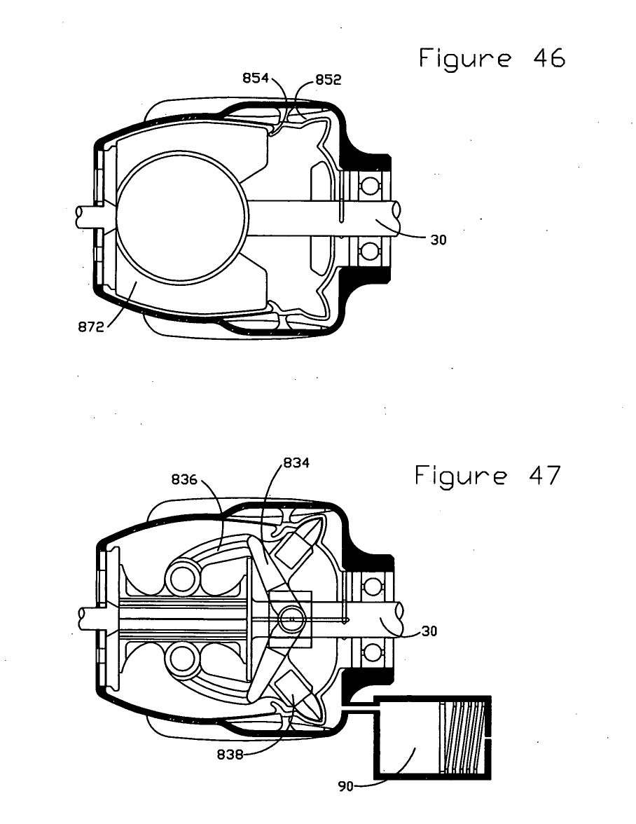

FIG. 46 shows a cross sectional view with the top end of the cylinder. Extending outwardly from the cylinder is an oil distribution baffle 872. The baffles extend outwardly from the cylinder and may be slightly twisted, as in the manner of a propeller, rather than being planar. The twist would be about a horizontal axis when the baffles are in the orientation of FIG. 46. In the orientation shown in FIG. 46, oil within the engine cavity would collect at the bottom of the housing. Rotation of the baffles 872 cause centrifugal forces to move the oil outwardly and evenly about the interior of the housing. As mentioned previously, a scoop 854 is provided to direct the oil into the oil jacket 852, after which it is distributed throughout oil channels to all parts needing lubrication.

FIG. 47 shows the engine provided with a pressurized oil reservoir 90. One end of the reservoir is in fluid communication with the interior of the engine, whereas the opposite chamber of the oil reservoir, on the other side of a piston, is provided with a pressure regulator, such as a spring, the maintains the pressure within the oil reservoir. Other forms of pressure, such as pressurized air, may be utilized with equal effect. By regulating the oil pressure, the amount of oil within a housing can be controlled. Providing the right amount of oil for lubrication, without excess, which would interfere with rotation of the internal parts, is desirable.

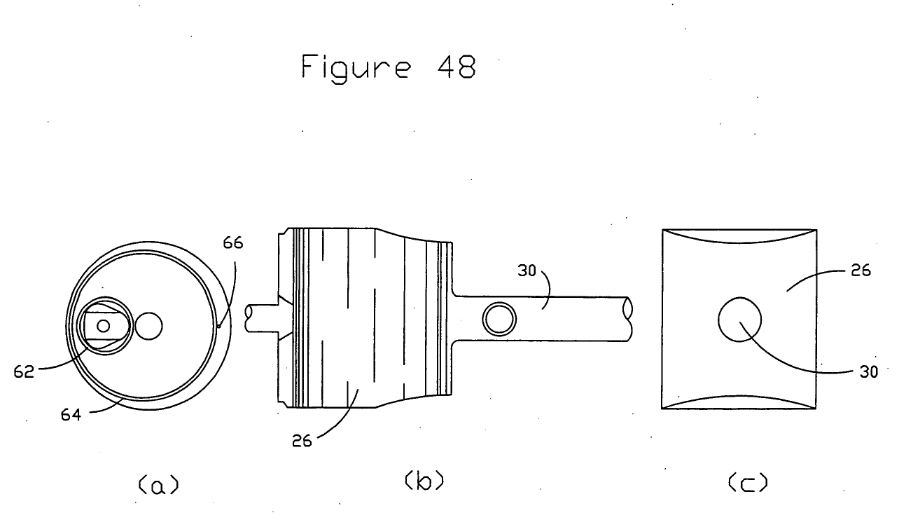

FIGS. 48a-c shows the front, right and side views of the cylinder. The front end view has already been discussed with reference to FIG. 44 and will not be discussed further here. Seen in FIG. 48a is oil port 66 formed in the side of the cylinder. This provides lubrication between the side of the cylinder and the side of the housing. The side view of FIG. 48b shows the varying height of the cylinder walls for reasons explained with reference to FIG. 39. FIG. 48c shows the right end view of the cylinder with the shaft extending from the cylinder and the top edge of the cylinder.

While the invention has been described with reference to an internal combustion engine, each embodiment may be used as a pump. If the drive shaft is driven by an external source, rotation of the cylinder and reciprocal motion of the pistons results. In this instance, the combustion chamber is now the pumping chamber and fluids, gases or liquids, are moved between the intake and exhaust ports. The parts may be made of plastic and the pump can be used in medical applications.

I claim:

1. A rotary engine comprising:
a housing,
a rotor within said housing,
a driveshaft extending from said rotor,
a pair of pistons mounted within said rotor for reciprocal motion, and
a linkage extending from said pair of pistons to said drive shaft.

2. The rotary engine of claim 1, wherein said linkage is pivotally connected to said pistons.

3. The rotary engine of claim 1, wherein said linkage is slidably connected to said pistons.

4. The rotary engine of claim 1, further comprising:
a cam formed in said housing,
said linkage includes a cam extension, and
said cam extension engaging said cam.

5. The rotary engine of claim 1, wherein said linkage is connected to a hub, said hub slidable along said driveshaft.

6. The rotary engine of claim 1, wherein said linkage has oil channels.

7. The rotary engine of claim 1, wherein each piston has a top face,
a central depression formed in said top face, and a spiral channel extending from the edge of the piston to said central depression.

8. A rotary engine comprising:
a housing having a sidewall, a first end wall and a second end wall,
a rotor within said housing, the rotor having a first sidewall next to the housing first side wall,
a driveshaft extending from said rotor,
an inlet port and an outlet port in said housing first end wall,
a first port in said rotor first sidewall, and
a first seal about said first port.

9. The rotary engine of claim 8, further comprising a second seal extending about said first seal.
